(19) United States
(12) Patent Application Publication
(10) Pub. No.: US 2013/0234824 A1
(43) Pub. Date: Sep. 12, 2013

(54) Method, System and Program Product for Communicating Between Mobile Devices

(71) Applicant: Sergiy Lozovsky, Santa Clara, CA (US)

(72) Inventor: Sergiy Lozovsky, Santa Clara, CA (US)

(21) Appl. No.: 13/417,221

(22) Filed: Mar. 10, 2012

(51) Int. Cl. G05B 19/02

(52) U.S. Cl. 340/4.3

(57) ABSTRACT

A method, system and program product comprise selecting data for communication between a first programmable mobile device and a second programmable mobile device, in which the first programmable mobile device and the second programmable mobile device are configured to be operable in modes for producing and detecting sound waves, mechanical vibrations, and images. At least one carrier is modulated with at least the selected data to form a message, in which the carrier is compatible with at least one producing and detecting mode of the first programmable mobile device and the second programmable mobile device. The message is transmitted between the first programmable mobile device and the second programmable mobile device using at least the compatible mode, wherein a received message is at least demodulated to recover the selected data.

### CROSS-REFERENCE TO RELATED APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to communication systems. More particularly, one or more embodiments of the invention relate to communication devices for communication systems.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Communication capabilities continue to expand and grow on a global basis. Communication devices may communicate via a number of ways with examples including wired, wireless and/or optical avenues. As an example, communication devices may be configured as cellular phones, smartphones, tabular computing devices or laptop computing devices. However, in some cases, conventional communication via a global communication network is prohibited (e.g. plane, hospital, etc.) or is unavailable (e.g. rural areas).

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram of an example communication system, in accordance with an embodiment of the present invention;

FIG. 2 is a block diagram of the example communication device described with reference to FIG. 1, in accordance with an embodiment of the present invention;

FIG. 3 is a diagram of an example communication system, in accordance with an embodiment of the present invention;

FIG. 4 illustrates an example method for the communication system as described with reference to FIGS. 1-3, in accordance with an embodiment of the present invention;

FIG. 5 illustrates a block diagram depicting a conventional client/server communication system; and

FIG. 6 illustrates a typical computer system that, when appropriately configured or designed, may serve as a computer system 600 for which the present invention may be embodied.

Unless otherwise indicated illustrations in the figures are not necessarily drawn to scale.

### DETAILED DESCRIPTION OF SOME EMBODIMENTS

Embodiments of the present invention are best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present application or of any further application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

“Software” may refer to prescribed rules to operate a computer. Examples of software may include: code segments in one or more computer-readable languages; graphical and or/textual instructions; applets; pre-compiled code; interpreted code; compiled code; and computer programs.

A “computer-readable medium” may refer to any storage device used for storing data accessible by a computer. Examples of a computer-readable medium may include: a magnetic hard disk; a floppy disk; an optical disk, such as a CD-ROM and a DVD; a magnetic tape; a flash memory; a memory chip; and/or other types of media that can store machine-readable instructions thereon.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

A non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; however, the non-transitory computer readable medium does not include a pure transitory signal per se.

Some embodiments of the present invention will be described which provide means and methods for a communication system using sound waves for performing communication.

Other embodiments of the present invention will be described which provide means and methods for a communication system using video (e.g. barcodes) avenues for performing communication.

Other embodiments of the present invention will be described which provide means and methods for a communication system using mechanical (e.g. vibration) avenues for performing communication.

Some embodiments enable point-to-point communication via sound, video and mechanical between a pair of communication devices or between multiplicities of communication devices.

Some embodiments provide routing capabilities via sound, video and mechanical avenues.

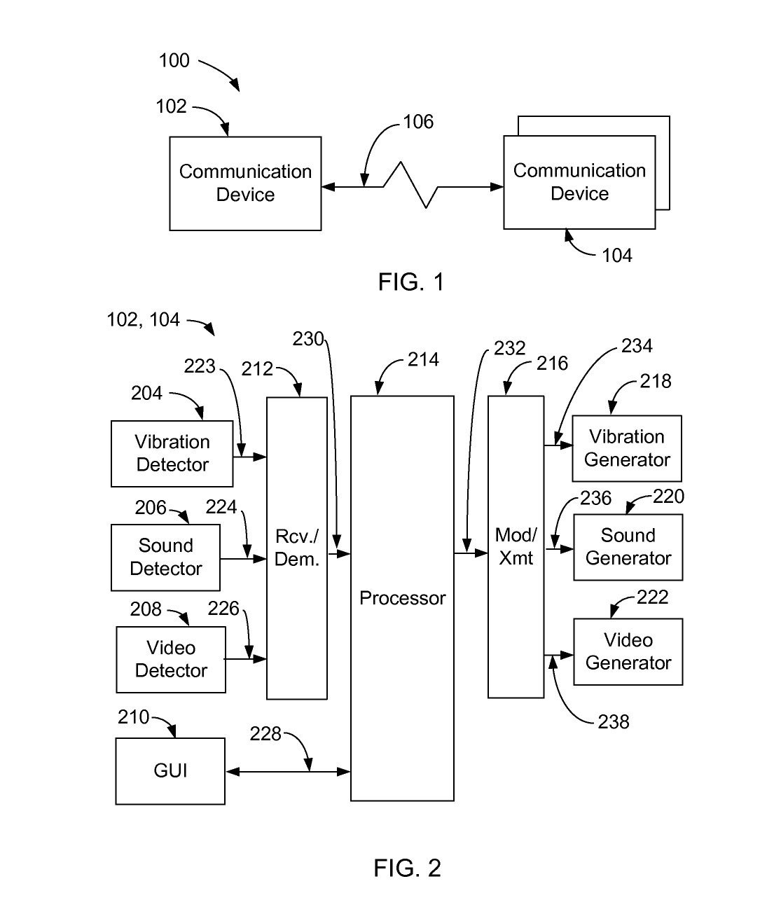

Some embodiments of the present invention will now be described in detail with reference to FIGS. 1-6.

FIG. 1 is a diagram of an example communication system, in accordance with an embodiment of the present invention.

A communication system 100 includes a communication device 102 and a multiplicity of communication devices with a sampling noted as a communication device 104.

Communication device 102 communicates bi-directionally or uni-directionally with communication device 102 via a communication channel 106.

Communication system 100 provides capability for receiving, storing, retrieving and processing.

Communication device 102 and 104 provide capability for performing communication with other communication devices.

Non-limiting examples for operation of communication channel 106 include audio, video or mechanical.

For audio operation, information is encoded as sound and transmitted as sound waves via the atmosphere from a first communication device. Transmitted sound waves are received by a microphone associated with a second communication device or a multiplicity of communication devices. Furthermore, the received sound waves are processed and decoded as digital information. Communication between devices is performed via the transmission and reception of sound waves. Non-limiting examples for sound waves include audible and non-audible sound waves associated with the human audio reception spectrum. As a non-limiting example, communication devices may communicate via simplex or duplex. Furthermore, devices may communicate as pairs or as a group. Non-limiting examples for encoding include Dual Tone Multi-Frequency (DTMF), facsimile (CCITT T.4, CCITT T.6, etc.) and modem (e.g. K56, K56flex, V.34, V.92, etc.). Communication via communication channel 106 supports collision avoidance/detection. As a non-limiting example, a user associated with communication device 102 seeks to communicate information to a user associated with communication device 104. Non-limiting examples for communicated information include audio, video, images, pictures, URLs, IP addresses and applications. User selects to transfer information from communication device 102 to communication device 104 with information communicated via communication channel 106. Furthermore, communication device 104 receives, processes and presents communicated information to user associated with communication device 104. As a non-limiting example, communication device 102 encodes data to a sequence of DTMF tones and plays these tones on a speaker. Communication device 104 hears these tones and decodes them into the original data. As an another non-limiting example, a user communicates information to a multiplicity of other persons via communication device 102, communication channel 106 and the communication devices associated with the multiplicity of other persons.

For video operation, information is encoded as a stream of video images. Non-limiting examples of video images include bar codes, color codes and Quick Response (QR) codes. Video stream is encoded and communicated via light with the receiving communication device receiving and processing the received light. Non-limiting examples for devices generating light include LED/LCD screens/panels, Light Emitting Diodes (LEDs) and Light Amplification by Stimulated Emission of Radiation (LASER).

For mechanical operation, information is encoded via a vibration generation device associated with the transmitting communication device and transmitted via communication channel 106. Receiving communication device receives and processes vibration encoded information. A non-limiting example of a device for decoding vibration encoded information is an accelerometer. Communication devices may transfer vibration information by touching or via the devices touching an intermediary structure. Furthermore, for an intermediary structure, the vibration information traverses the dimensions of intermediary structure for reception by the receiving communication device. A non-limiting example of an intermediary structure for transferring vibration information is a table. Non-limiting examples for communication devices include mobile phones, smartphones and laptop computing device.

As a non-limiting example of operation, a small amount of data may be transferred, such as, but not limited to, a Facebook® ID. In this example, in a manual mode, a user of communication device 102 may click an application button, “become friends”, on his device. Communication device 102 may then access the required data and wait for the user to click a “send” button. In an automatic mode, communication device 102 waits for a sensor such as, but not limited to, a proximity censor to detect another device. Proximity sensors are often used to turn off the screen of a smart phone when user moves it to the head. Proximity sensor may react to any object, but for current application user can wave his phone 102 near 104 to trigger the transmission. In other non-limiting examples, other events may trigger transmission, for example, a camera sees image of another phone or particular image on the screen of another phone and communication device 102 starts transmission when it is put in proximity/waved near communication device 104. During data transfer, communication device 102 transmits an operation code (“become friends”) and Facebook® UI with an optional CRC and/or redundancy data. Communication device 104 (and optionally other devices) receive the operation code and Facebook® UI and optionally checks CRC (or recover information if needed and redundancy is enabled), then executes the request over the Internet. In another non-limiting variation, communication device 102 transmits an operation code “want to become friends”. Communication device 104 responds with operation code “become friends” and Facebook® UI. Communication device 102 receives the operation code and Facebook® UI, checks CRC (or recover information if needed and redundancy is enabled), and executes the request over the Internet. In another non-limiting variation, operation code can be dropped. The user of communication device 104 clicks a button “listen to become friends”. Communication device 104 starts listening for Facebook® UI. User of communication device 102 clicks a button “become friends” and transmits Facebook® UI. This embodiment makes protocol simpler, but requires additional action on part of communication device 104.

In a non-limiting example for a protocol that may be used with the above examples, the operation code may be two digits such as, but not limited to, 01 for “become friends” followed by N digits of data, and 02 for “listen to become friends”. Silence may mark the end of a message. In another non-limiting example, extensions to the protocol may be used. Extensions may include, but not limited to, a Preamble “*” to mark start of a message, a Trailer “#” to mark an end of a message, CRC, redundancy data, reception acknowledgment, collision avoidance and/or detection, etc. In other non-limiting examples, PPP, WiFi or Bluetooth like protocols may be used on top of the above described ones. In other non-limiting examples, IP may be used on top of PPP, WiFi or Bluetooth like protocols.

As another non-limiting example of operation, “human voice” or a replicated “human voice” may be used. In the above examples, one communication device may say “Let's be friends on Facebook®!”. The other communication device may respond with “Ok. My Facebook® name is Silverbullet.” Although human voice is not most effective way to transmit data, it may add entertainment value for the users.

FIG. 1 is a diagram of an example communication system where information may be communicated via audio, video or mechanical.

FIG. 2 is a block diagram of the example communication device described with reference to FIG. 2, in accordance with an embodiment of the present invention.

Communication device 102 includes a vibration detector portion 204, a sound detector portion 206, a video detector portion 208, a Graphical User Interface (GUI) portion 210, a receiver/demodulator portion 212, a processor portion 214, a modulator/transmitter portion 216, a vibration generator portion 218, a sound generator portion 220 and a video generator portion 222. Communication device 104 as described with reference to FIG. 1 may also be configured as described with reference to FIG. 2.

Communication device 102 provides capability for transmitting, receiving, processing and presenting communicated information.

Receiver/demodulator portion 212 receives information from vibration detector portion 204 via a communication channel 223, from sound detector portion 206 via a communication channel 224 and from video detector portion 208 via a communication channel 226. GUI PORTION 210 communicates bi-directionally with processor portion 214 via a communication channel 228. Processor portion 214 receives information from receiver/demodulator portion 212 via a communication channel 230. Modulator/transmitter portion 216 receives information from processor portion 214 via a communication channel 232. Vibration generator portion 218 receives information from modulator/transmitter portion 216 via a communication channel 234. Sound generator portion 220 receives information from modulator/transmitter portion 216 via a communication channel 236. Video generator portion 222 receives information from processor portion 214 via a communication channel 238.

Vibration detector portion 204 provides capability for receiving and processing vibration encoded information. Sound detector portion 206 provides capability for receiving and processing sound encoded information. Video detector portion 208 provides capability for receiving and processing video encoded information. GUI PORTION 210 provides capability for interfacing with a user via presentation and reception of information associated with user. Receiver/demodulator portion 212 provides capability for receiving, demodulating and processing received information. Non-limiting examples of protocols processed by receiver/demodulator portion 212 include DTMF, V.34, Bluetooth and WiFi. Bluetooth is a proprietary open wireless technology for bi-directional communication. WiFi uses IEEE 802.11 family of standards for bi-directional wireless communication. For this application, the information may be decoded via exemplary protocols (e.g. Bluetooth, WiFi, etc.) and transported via sound, video or mechanical mediums. Processor portion 214 provides capability to process transmission and reception of information and to provide management of communication device 102. Modulator/transmitter portion 216 provides capability for performing modulation and transmission of information. Non-limiting examples for protocols supported by modulator/transmitter portion 216 for encoding information include DTMF, V.34, Bluetooth and WiFi. Vibration generator portion 218 provides capability for transmitting information mechanically. Sound generator portion 220 provides capability for transmitting information via sound waves associated with the atmosphere. Video generator portion 222 provides capability for transmitting information via light.

Via vibration generator portion 218, sound generator portion 220 and/or video generator portion 222, communication device 102 can transmit information to a second communication device. Furthermore, following receipt of information from communication device 102, second communication device can establish a communication connection via other channels/protocols. Non-limiting examples for other channels/protocols include wireless channels/protocols using Bluetooth, WiFi and Internet. Furthermore, group communication may be performed between communication device 102 and a multiplicity of associated communication devices using sound, video and/or mechanical capabilities.

Communication device 102 may transmit information to a second communication device requesting retrieval of information which may be delivered at a later point in time. As a non-limiting example, requested information is a picture or image associated with a global communications network. As another non-limiting example, information associated with request may be for efforts associated with a social network (e.g. becoming friends, communicating, etc.). Furthermore, request may be requested with delivery performed at a later point in time due to unavailability of a global communication network (e.g. requested during airplane flight).

Communication device 102 supports communication via sound, video and/or mechanical while communication device 102 operates as a mobile telephone device. As a non-limiting example, two persons having a phone conversation may transmit and receive information via sound, video and/or mechanical during the course of the phone conversation.

Communication device 102 supports off-line modulation and/or demodulation where completion of information processing is completed at a delayed point in time as compared to the time of receipt.

As a non-limiting example, in operation, a user associated with communication device 102 seeks to communicate information (e.g. picture, image, etc.) to a second communication device; user selects information to transmit and selects address/identifier associated with the second device. Communication device 102 communicates information to second communication device for establishing a communication link for exchanging information. Non-limiting examples of information communicated include Service Set Identifier (SSID), Media Access Control address (MAC) and security associated password. Following receipt of information from communication device 102, second communication device notifies an associated user of a request for establishing a communication link. User associated with second communication device may confirm or acknowledge establishment of a communication link with communication device 102. After establishment of the communication link between communication device 102 and the second communication device, exchanges of information may be communicated between the devices. The established communication link may be configured for secure transfer of information. As an alternate non-limiting example, in operation, a user associated with communication device 102 seeks to communicate information (e.g. picture, image, etc.) to a second communication device. User selects information to transmit and then selects to broadcast the information. The second communication device may then be configured to listen for broadcasts. Upon detection of the broadcast, the second communication device may simply receive the information without having to establish a communication link.

FIG. 2 is a block diagram of the example communication device described with reference to FIG. 1 where a communication device is configured for communicating with other communication devices via sound, video and mechanical avenues.

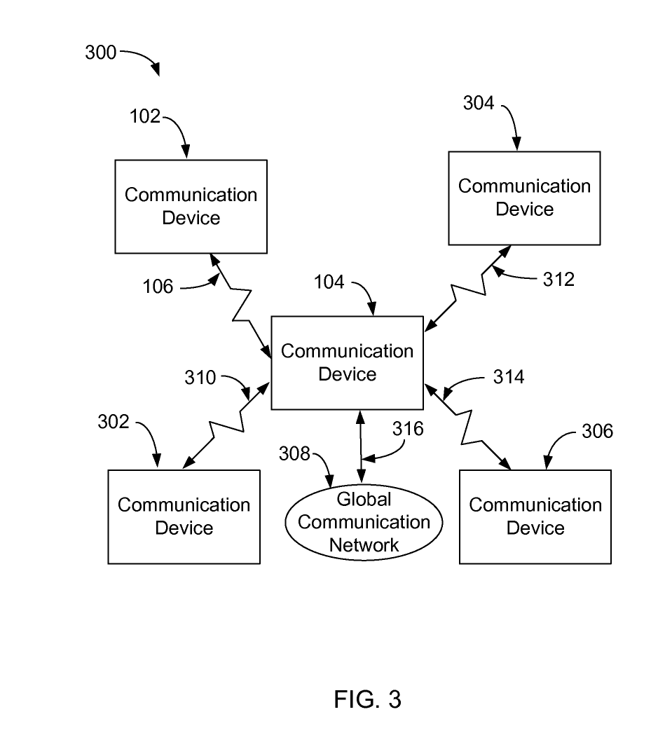

FIG. 3 is a diagram of an example communication system, in accordance with an embodiment of the present invention.

A communication system 300 includes communication device 102, communication device 104, a communication device 302, a communication device 304, a communication device 306 and a global communication network 308.

Communication device 104 communicates bi-directionally with communication device 102 via communication channel 106, with communication device 302 via a communication channel 310, with communication device 304 via a communication channel 312, with communication device 306 via a communication channel 314 and with global communication network 308 via a communication channel 316.

Communication channel 106, 310, 312 and 314 may communicate information via sound, video and/or mechanical avenues as described with reference to FIGS. 1-2.

Communication channel 316 may communicate information via conventional avenues (e.g. Ethernet, wireless, etc.).

Communication system 300 provides capability for receiving, storing, retrieving and processing.

For this embodiment, communication device 104 operates as a network router by routing information to various communication devices.

Communication device 104, 302, 304 and 306 operate as communication devices described with reference to FIGS. 1-2.

Global communication network 308 provides global communications with external entities (not shown).

In operation, as a non-limiting example, communication device 102 may seek to communicate information to communication device 302. Furthermore, as a non-limiting example, communication device 304 may seek to communicate information to communication device 306. Furthermore, communication device 104 receives information from communication device 102 destined for communication device 302 and routes the information to communication device 302. Furthermore, communication device 104 receives information from communication device 304 destined for communication device 306 and routes the information to communication device 306. Furthermore, as a non-limiting example, communication device 102 seeks to communicate information to an external entity or entities (not shown). Communication device 104 receives information destined for external entities and routes the information to the external entities via global communication network 308.

FIG. 3 is a diagram of an example communication system where a communication device may operate as a router for routing information from communication devices to other communication devices.

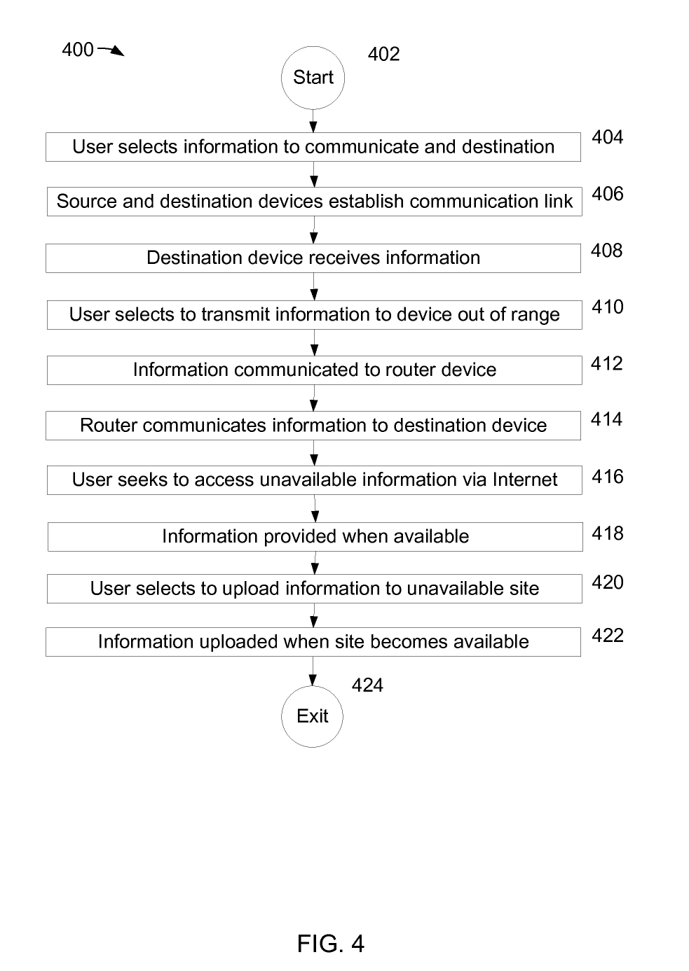

FIG. 4 illustrates an example method for the communication system as described with reference to FIGS. 1-3, in accordance with an embodiment of the present invention.

A method 400 initiates in a step 402.

Then in a step 404, user selects information to communicate and selects destination for delivery of information.

As a non-limiting example, user may select information to upload to a destination device and selects destination device via GUI portion 210 (FIG. 2). As an alternate non-limiting example, user may select information to upload to a destination device and then select to broadcast the information where the destination device is configured to listen, and simply receives the information.

Referring back to FIG. 4, then in a step 406, source and destination devices establish communication link.

As a non-limiting example, communication device 102 (FIG. 1) and communication device 104 (FIG. 1) establish a communication link via communication channel 106 (FIG. 1).

Referring back to FIG. 4, then in a step 408, destination device receives information.

As a non-limiting example, communication device 104 (FIG. 2), receives information via vibration detector portion 204 (FIG. 2), sound detector portion 206 (FIG. 2) and/or video detector portion 208 (FIG. 2). Furthermore, receiver/demodulator portion 212 (FIG. 2) receives and processes information from vibration detector portion 204 (FIG. 2), sound detector portion 206 (FIG. 2), and/or video detector portion 208 (FIG. 2). Furthermore, processor portion 214 (FIG. 2) receives information from receiver/demodulator portion 212 (FIG. 2) and presents information via GUI PORTION 210 (FIG. 2).

Referring back to FIG. 4, then in a step 410, user selects to transmit information to communication device currently out of range.

As a non-limiting example, user seeks to communicate information from communication device 102 (FIG. 3) to communication device 304 (FIG. 3). For this example, communication device 102 (FIG. 3) and communication device 304 (FIG. 3) are unable to communicate.

Referring back to FIG. 4, then in a step 412, information is communicated to router device.

As a non-limiting example, information is communicated from communication device 102 (FIG. 3) to communication device 104 (FIG. 3) with communication device 104 (FIG. 3) operating as a router.

Referring back to FIG. 4, then in a step 414, router communicates information to destination device.

As a non-limiting example, information is communicated from communication device 104 (FIG. 3) operating as a router to communication device 304 (FIG. 3).

Referring back to FIG. 4, then in a step 416, user seeks to access unavailable information via global communication network.

As a non-limiting example, user associated with communication device 102 (FIG. 3) seeks to access unavailable information via global communication network 308 (FIG. 3).

Referring back to FIG. 4, then in a step 418, information is provided to communication device when it becomes available.

As a non-limiting example, information via global communication network 308 (FIG. 3) becoming available, information is communicated to communication device 102 (FIG. 3).

Referring back to FIG. 4, then in a step 420, user selects to upload information to an unavailable site.

As a non-limiting example, user associated with communication device 102 (FIG. 3) seeks to upload information to an unavailable entity associated with global communication network 308 (FIG. 3).

Referring back to FIG. 4, then in a step 422, information is uploaded to site when site becomes available. As a non-limiting example, via communication device 104 (FIG. 3) operating as a router.

As a non-limiting example, information is uploaded to global communication network 308 (FIG. 3) when site associated with global communication network 308 (FIG. 3) becomes available.

Then in a step 424, execution of method 400 terminates. As one of ordinary skill may readily recognize, the aforementioned steps may be executed in a variety of different orders, as global communication network 308 (FIG. 3), may communicate numerous ways. As a non-limiting example, devices may form association through sound/video/vibration (exchange/broadcast their addresses), try to reach each other through conventional means and if that fails, transmit data through sound/video/vibration.

FIG. 4 illustrates an example method for the communication system as described with reference to FIGS. 1-3 where information may be communicated point-to-point between devices and/or via a router and information may be uploaded/downloaded to entities associated with a global communication network when they become available.

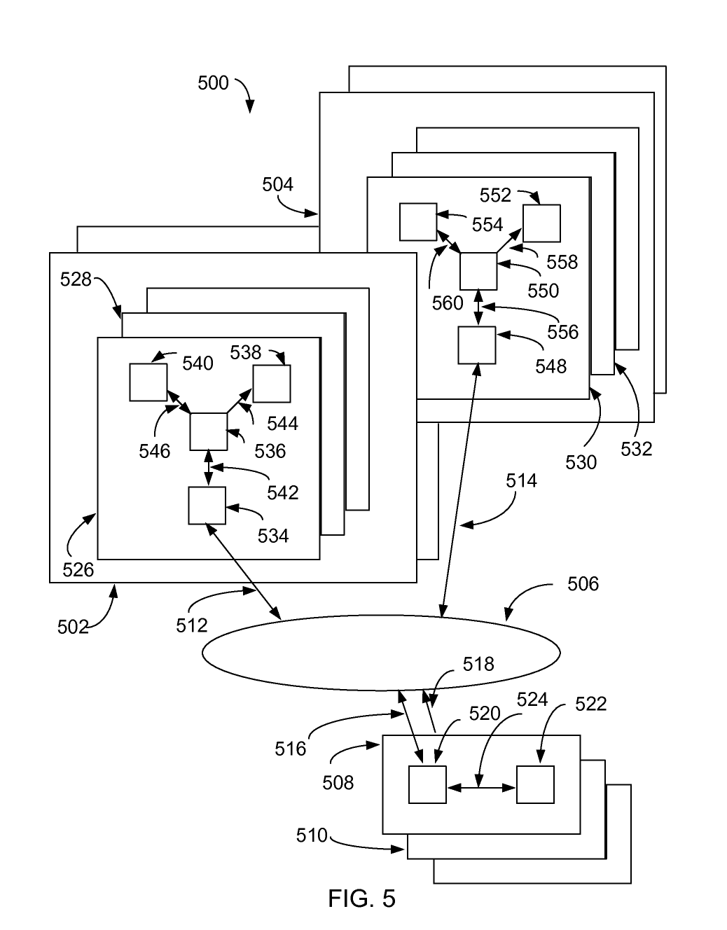

FIG. 5 illustrates a block diagram depicting a conventional client/server communication system.

A communication system 500 includes a multiplicity of networked regions with a sampling of regions denoted as a network region 502 and a network region 504, a global network 506 and a multiplicity of servers with a sampling of servers denoted as a server device 508 and a server device 510.

Network region 502 and network region 504 may operate to represent a network contained within a geographical area or region. Non-limiting examples of representations for the geographical areas for the networked regions may include postal zip codes, telephone area codes, states, counties, cities and countries. Elements within network region 502 and 504 may operate to communicate with external elements within other networked regions or within elements contained within the same network region.

In some implementations, global network 506 may operate as the Internet. It will be understood by those skilled in the art that communication system 500 may take many different forms. Non-limiting examples of forms for communication system 500 include local area networks (LANs), wide area networks (WANs), wired telephone networks, cellular telephone networks or any other network supporting data communication between respective entities via hardwired or wireless communication networks. Global network 506 may operate to transfer information between the various networked elements.

Server device 508 and server device 510 may operate to execute software instructions, store information, support database operations and communicate with other networked elements. Non-limiting examples of software and scripting languages which may be executed on server device 508 and server device 510 include C, C++, C# and Java.

Network region 502 may operate to communicate bi-directionally with global network 506 via a communication channel 512. Network region 504 may operate to communicate bi-directionally with global network 506 via a communication channel 514. Server device 508 may operate to communicate bi-directionally with global network 506 via a communication channel 516. Server device 510 may operate to communicate bi-directionally with global network 506 via a communication channel 518. Network region 502 and 504, global network 506 and server devices 508 and 510 may operate to communicate bi-directionally and also communicate bi-directionally with other networked device located within communication system 500.

Server device 508 includes a networking device 520 and a server 522. Networking device 520 may operate to communicate bi-directionally with global network 506 via communication channel 516 and with server 522 via a communication channel 524. Server 522 may operate to execute software instructions and store information.

Network region 502 includes a multiplicity of clients with a sampling denoted as a client 526 and a client 528. Client 526 includes a networking device 534, a processor 536, a GUI 538 and an interface device 540. Non-limiting examples of devices for GUI 538 include monitors, televisions, cellular telephones, smartphones and PDAs (Personal Digital Assistants). Non-limiting examples of interface device 540 include pointing device, mouse, trackball, scanner and printer. Networking device 534 may communicate bi-directionally with global network 506 via communication channel 512 and with processor 536 via a communication channel 542. GUI 538 may receive information from processor 536 via a communication channel 544 for presentation to a user for viewing. Interface device 540 may operate to send control information to processor 536 and to receive information from processor 536 via a communication channel 546. Network region 504 includes a multiplicity of clients with a sampling denoted as a client 530 and a client 532. Client 530 includes a networking device 548, a processor 550, a GUI 552 and an interface device 554. Non-limiting examples of devices for GUI 538 include monitors, televisions, cellular telephones, smartphones and PDAs (Personal Digital Assistants). Non-limiting examples of interface device 540 include pointing devices, mousse, trackballs, scanners and printers. Networking device 548 may communicate bi-directionally with global network 506 via communication channel 514 and with processor 550 via a communication channel 556. GUI 552 may receive information from processor 550 via a communication channel 558 for presentation to a user for viewing. Interface device 554 may operate to send control information to processor 550 and to receive information from processor 550 via a communication channel 560.

For example, consider the case where a user interfacing with client 526 may want to execute a networked application. A user may enter the IP (Internet Protocol) address for the networked application using interface device 540. The IP address information may be communicated to processor 536 via communication channel 546. Processor 536 may then communicate the IP address information to networking device 534 via communication channel 542. Networking device 534 may then communicate the IP address information to global network 506 via communication channel 512. Global network 506 may then communicate the IP address information to networking device 520 of server device 508 via communication channel 516. Networking device 520 may then communicate the IP address information to server 522 via communication channel 524. Server 522 may receive the IP address information and after processing the IP address information may communicate return information to networking device 520 via communication channel 524. Networking device 520 may communicate the return information to global network 506 via communication channel 516. Global network 506 may communicate the return information to networking device 534 via communication channel 512. Networking device 534 may communicate the return information to processor 536 via communication channel 542. Processor 536 may communicate the return information to GUI 538 via communication channel 544. User may then view the return information on GUI 538.

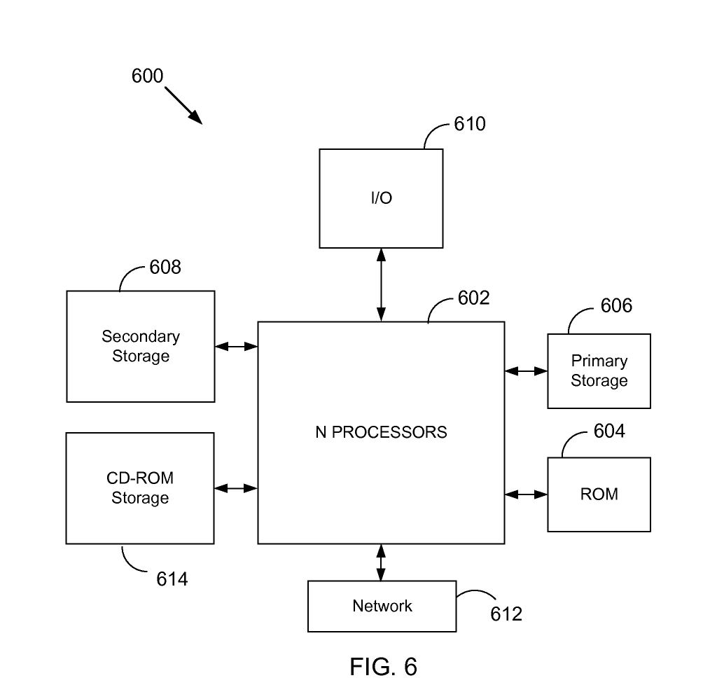

FIG. 6 illustrates a typical computer system that, when appropriately configured or designed, may serve as a computer system 600 for which the present invention may be embodied.

Computer system 600 includes a quantity of processors 602 (also referred to as central processing units, or CPUs) that may be coupled to storage devices including a primary storage 606 (typically a random access memory, or RAM), a primary storage 604 (typically a read-only memory, or ROM). CPU 602 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors. As is well known in the art, primary storage 604 acts to transfer data and instructions uni-directionally to the CPU and primary storage 606 typically may be used to transfer data and instructions in a bi-directional manner. The primary storage devices discussed previously may include any suitable computer-readable media such as those described above. A mass storage device 608 may also be coupled bi-directionally to CPU 602 and provides additional data storage capacity and may include any of the computer-readable media described above. Mass storage device 608 may be used to store programs, data and the like and typically may be used as a secondary storage medium such as a hard disk. It will be appreciated that the information retained within mass storage device 608, may, in appropriate cases, be incorporated in standard fashion as part of primary storage 606 as virtual memory. A specific mass storage device such as a CD-ROM 614 may also pass data uni-directionally to the CPU.

CPU 602 may also be coupled to an interface 610 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 602 optionally may be coupled to an external device such as a database or a computer or telecommunications or internet network using an external connection shown generally as a network 612, which may be implemented as a hardwired or wireless communications link using suitable conventional technologies. With such a connection, the CPU might receive information from the network, or might output information to the network in the course of performing the method steps described in the teachings of the present invention.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112 (6). In some embodiments, the methods and/or system components which may be located and/or performed remotely include, without limitation: servers and global network.

It is noted that according to USA law, all claims must be set forth as a coherent, cooperating set of limitations that work in functional combination to achieve a useful result as a whole. Accordingly, for any claim having functional limitations interpreted under 35 USC §112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC §112 (6) is/(are) dependent on one or more remote servers located outside the USA, it is intended that each such recited function under 35 USC §112 (6) is to be interpreted as the function of the local system receiving the remotely generated information required by a locally implemented claim limitation, wherein the structures and or steps which enable, and breath life into the expression of such functions claimed under 35 USC §112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC §112 (6)” should be replaced with the closest corresponding statute in the patent laws of such pertinent country or countries or legal organization(s).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods for the communication devices according to the present invention will be apparent to those skilled in the art. The invention has been described above by way of illustration, and the specific embodiments disclosed are not intended to limit the invention to the particular forms disclosed. For example, the particular implementation of the GUI may vary depending upon the particular type of communication device used. The communication devices described in the foregoing were directed to smartphone implementations; however, similar techniques using laptop computing device implementations of the present invention are contemplated as within the scope of the present invention. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. A method comprising the steps of:
selecting data for communication between a first programmable mobile device and a second programmable mobile device, in which the first programmable mobile device and the second programmable mobile device are configured to be operable in modes for producing and detecting sound waves, mechanical vibrations, and/or images;
modulating at least one carrier with at least the selected data to form a message, in which the carrier is compatible with at least one producing and detecting mode of the first programmable mobile device and the second programmable mobile device; and
transmitting the message between the first programmable mobile device and the second programmable mobile device using at least the compatible mode, wherein a received message is at least demodulated to recover a portion of the selected data.

2. The method as recited in claim 1, further comprising the step of establishing a communication link between the first programmable mobile device and the second programmable mobile device.

3. The method as recited in claim 1, further comprising the step of appending extensions to said selected data, said extensions at least comprising an operational code and/or error correcting code.

4. The method as recited in claim 2, further comprising the step of applying a data transfer protocol.

5. The method as recited in claim 1, further comprising the steps of modulating an additional carrier with additional selected data to form an additional message, in which the additional carrier is compatible with a producing and detecting mode not being used for transmitting the message, and transmitting the additional selected message.

6. The method as recited in claim 1, in which the received message is routed to a third programmable mobile device.

7. The method as recited in claim 1, in which said transmitting further broadcasts the message to a plurality of programmable mobile devices.

8. The method as recited in claim 1, in which the carrier comprises a replicated human voice.

9. The method as recited in claim 1, in which the carrier comprises a stream of images comprising a plurality of codes.

10. A system comprising:
a first programmable mobile device being configured to be operable in modes for producing and detecting sound waves, mechanical vibrations, and/or images, said first programmable mobile device further comprising a modulation unit being configured to be operable for modulating at least one transmit carrier being compatible with at least one producing mode, and a demodulation unit being configured to be operable for demodulating at least one receive carrier being compatible with at least one detecting mode, in which at least a selected data modulates said transmit carrier to form a message, and the message is transmitted in a producing mode; and
a second programmable mobile device being configured to be operable in modes for producing and detecting sound waves, mechanical vibrations, and images, said second programmable mobile device further comprising a modulation unit being configured to be operable for modulating at least one transmit carrier being compatible with at least one producing mode, and a demodulation unit being configured to be operable for demodulating at least one receive carrier being compatible with at least one detecting mode, in which the message is received as a receive carrier in a detecting mode and the message is demodulated to at least recover a portion of the selected data.

11. The system as recited in claim 10, in which said first programmable mobile device and said second programmable mobile device are further configured to operable for establishing a communication link.

12. The system as recited in claim 10, in which extensions are appended to said selected data, said extensions at least comprising an operational code and/or error correcting code.

13. The system as recited in claim 11, in which a data transfer protocol is applied to said message.

14. The system as recited in claim 10, in which said first programmable mobile device modulates an additional transmit carrier with additional selected data to form an additional message, in which said additional carrier is compatible with a producing and detecting mode not being used for transmitting said message, and said additional selected message is transmitted in a producing mode to be received by said second programmable mobile device.

15. The system as recited in claim 10, in which said received message is routed to a third programmable mobile device.

16. The system as recited in claim 10, in which said first programmable mobile device further broadcasts said message to a plurality of programmable mobile devices.

17. The system as recited in claim 10, in which said transmit carrier comprises a replicated human voice.

18. The system as recited in claim 10, in which said transmit carrier comprises a stream of images comprising a plurality of bar codes.

19. A non-transitory program storage device readable by a machine tangibly embodying a program of instructions executable by the machine to perform a method for communicating data, comprising:
computer code for selecting data for communication between a first programmable mobile device and a second programmable mobile device, in which the first programmable mobile device and the second programmable mobile device are configured to be operable in modes for producing and detecting sound waves, mechanical vibrations, and/or images;
computer code for modulating at least one carrier with at least the selected data to form a message, in which the carrier is compatible with at least one producing and detecting mode of the first programmable mobile device and the second programmable mobile device; and
computer code for transmitting the message between the first programmable mobile device and the second programmable mobile device using at least the compatible mode, wherein a received message is at least demodulated to recover at least a portion of the selected data.

20. The non-transitory program storage device as recited in claim 19, further comprising:
computer code for the step of establishing a communication link between the first programmable mobile device and the second programmable mobile device;
computer code for appending extensions to said selected data, said extensions at least comprising an operational code and/or error correcting code;
computer code for applying a data transfer protocol;
computer code for modulating an additional carrier with additional selected data
to form an additional message, in which the additional carrier is compatible with a producing and detecting mode not being used for transmitting the message, and transmitting the additional selected message;
computer code for routing the received message a third programmable mobile device; and
computer code for broadcasting the message to a plurality of programmable mobile devices.
